(19) United States
(12) Patent Application Publication
(10) Pub. No.: US 2019/0139431 A1
(43) Pub. Date: May 9, 2019

(54) CONTEXTUAL TEST ALTERATION

(71) Applicant: INTERNATIONAL BUSINESS MACHINES CORPORATION, ARMONK, NY (US)

(72) Inventors: Michael S. Gordon, Yorktown Heights, NY (US); Clifford A. Pickover, Yorktown Heights, NY (US); Komminist Weldemariam, Nairobi (KE)

(21) Appl. No.: 15/805,656

(22) Filed: Nov. 7, 2017

(51) Int. Cl. G09B 7/00; H04N 7/18

(52) U.S. Cl. CPC G09B 7/00; G06K 7/10366; H04N 7/183

(57) ABSTRACT

A method, computer system, and computer program product. Contextual data associated with a test administration is received. A likelihood of an incident of a cheating event by a test-taker is determined based on a predefined criterion that is met by the received contextual data. A test alteration is generated based on testing data and tested subject matter data related to a test administered to the test-taker during the test administration in accordance with the determined likelihood of the incident of the cheating event. The test administered to the test-taker is updated based on the generated test alteration.

### BACKGROUND

The present invention relates generally to test administration, and in particular to methods and systems for preventing test-taking fraud.

A test or examination is administered to a person or subject, such as a test-taker, with the intention of assessing and measuring the subject's knowledge, skill, aptitude, or fitness in one or more topics or domains. The test may be administered to the subject in verbal form, written form, digital form, or the like. In some instances, the subject may attempt to cheat on the test, or to otherwise commit test-taking fraud, to obtain a desired score or grade. For example, the subject may copy another test-taker's answers, the subject may send a proxy to take the test for the subject, the subject may bring and use notes during the test where such may be prohibited, or the subject may obtain and utilize an answer key to the test.

Efforts to prevent or identify cheating on tests include, for example, employing multiple test proctors to monitor test-takers during test administration, constructing variants of a particular test to be respectively administered to different test-takers during test administration, inspecting answers on tests completed by suspected cheaters, and the like. Despite these efforts, cheating on tests is still commonly and successfully practiced, and persists as an issue in the administration of tests or examinations.

### SUMMARY

Aspects of the present invention are directed to a method, system, and computer program product.

According to an aspect of the present invention, a method is provided. The method may include receiving contextual data associated with a test administration. A likelihood of an incident of a cheating event by a test-taker may then be determined based on a predefined criterion that is met by the received contextual data. A test alteration may then be generated based on testing data and tested subject matter data related to a test administered to the test-taker during the test administration in accordance with the determined likelihood of the incident of the cheating event. The test administered to the test-taker may then be updated based on the generated test alteration.

According to an aspect of the present invention, a computer system is provided. The computer system may include one or more computer processors, one or more computer-readable storage media, and program instructions stored on one or more of the computer-readable storage media for execution by at least one of the one or more computer processors. The program instructions may be executed to perform the disclosed method.

According to an aspect of the present invention, a computer program product is provided. The computer program product may include one or more computer-readable storage devices and program instructions stored on at least one of the one or more computer-readable storage devices for execution by at least one or more computer processors of a computer system. The program instructions may be executed by the at least one or more computer processors of the computer system to perform the disclosed method.

### BRIEF DESCRIPTION OF THE DRAWINGS

FIG. 1 is a functional block diagram depicting a test integrity management system, in accordance with an embodiment of the present invention.

FIG. 2 is a flowchart depicting operational steps of an aspect of a test integrity management system, in accordance with an embodiment of the present invention.

FIG. 3 is a block diagram depicting a sensor data device, media device, demographics device, test data device, user device, and/or test integrity management device, in accordance with an embodiment of the present invention.

FIG. 4 depicts a cloud computing environment, in accordance with an embodiment of the present invention.

FIG. 5 depicts abstraction model layers, in accordance with an embodiment of the present invention.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the present invention are disclosed herein for purposes of describing and illustrating claimed structures and methods that may be embodied in various forms, and are not intended to be exhaustive in any way, or limited to the disclosed embodiments. Many modifications and variations will be apparent to those of ordinary skill in the art without departing from the scope and spirit of the disclosed embodiments. The terminology used herein was chosen to best explain the principles of the one or more embodiments, practical applications, or technical improvements over current technologies, or to enable those of ordinary skill in the art to understand the embodiments disclosed herein. As described, details of well-known features and techniques may be omitted to avoid unnecessarily obscuring the embodiments of the present invention.

References in the specification to “one embodiment,” “an embodiment,” “an example embodiment,” or the like, indicate that the embodiment described may include one or more particular features, structures, or characteristics, but it shall be understood that such particular features, structures, or characteristics may or may not be common to each and every disclosed embodiment of the present invention herein. Moreover, such phrases do not necessarily refer to any one particular embodiment per se. As such, when one or more particular features, structures, or characteristics is described in connection with an embodiment, it is submitted that it is within the knowledge of those skilled in the art to affect such one or more features, structures, or characteristics in connection with other embodiments, where applicable, whether or not explicitly described.

A test may be administered to a person, such as by a workplace to an employee, to assess and measure the employee's knowledge, skill, and fitness in performing various tasks, and to accredit or qualify the employee accordingly where acceptable performance on the test is demonstrated. The purpose of administering tests, and the utility provided in doing so, is undermined when cheating occurs. For example, where the various tasks include various safety practices and measures used in supporting proper operation of a public transportation system, and where the employee receives improper accreditation in performing the various tasks by cheating on the test, the safety of passengers that use the public transportation system may consequently be threatened.

Embodiments of the present invention are directed to a system and method for preventing test-taking fraud. A likelihood that a cheating event may occur is determined with respect to a test administration in connection with a test-taker. A test alteration is generated for use in updating a test of the test-taker. A fairness value is determined with respect to the generated test alteration. Where the fairness value meets or exceeds a predetermined threshold value, the generated test alteration is adjusted, accordingly. The generated test alteration is used in updating the test of the test-taker to prevent the cheating event that may occur with respect to the test administration in connection with the test-taker.

Advantageously, generated test alterations used in respectively updating tests of test-takers suspected of cheating during a test administration, according to the present disclosure, can prevent cheating while also maintaining relative fairness in assessment with respect to peers or other test-takers of the tests. To that end, embodiments of the present invention have the capacity to improve the technical field of test administration by preserving and maintaining the integrity of test administrations, allowing for the preservation and maintenance of the utility provided thereby.

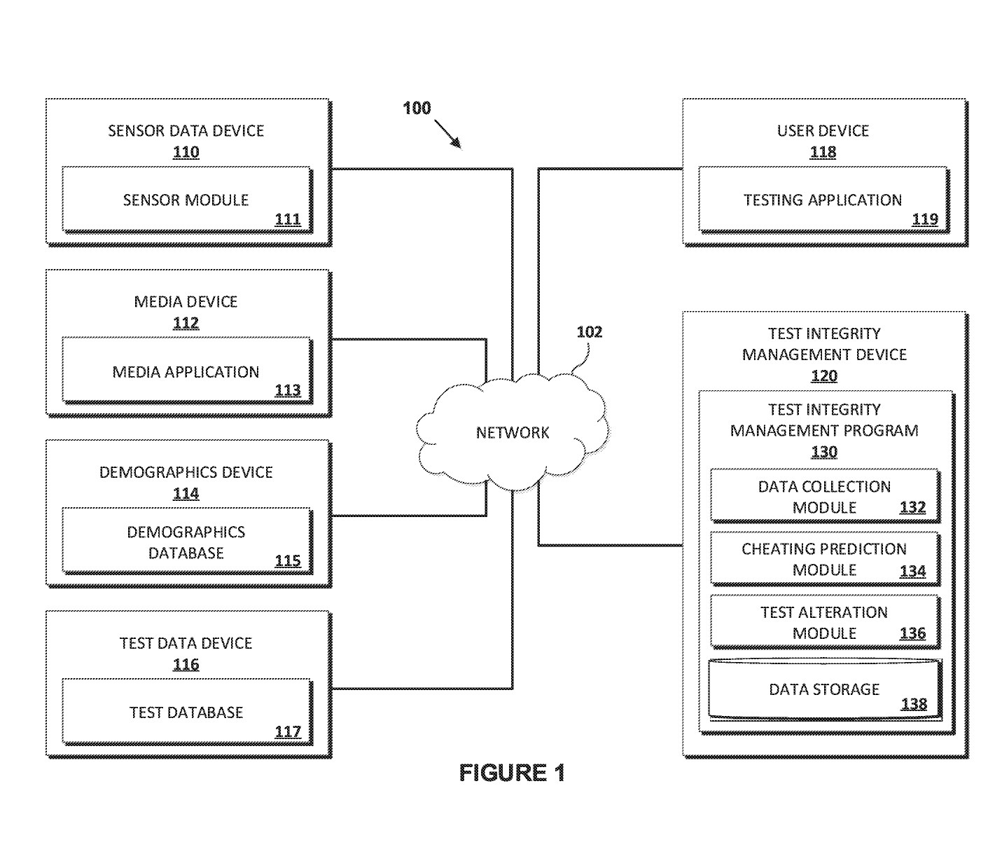

FIG. 1 is a functional block diagram depicting test integrity management system 100, in accordance with an embodiment of the present invention. Test integrity management system 100 may include sensor data device 110, media device 112, demographics device 114, test data device 116, user device 118, and test integrity management device 120 interconnected by way of network 102. While FIG. 1 depicts six discrete devices in test integrity management system 100, other arrangements may be contemplated. For example, sensor data device 110, media device 112, demographics device 114, test data device 116, user device 118, and test integrity management device 120 may be one or more integrated devices.

In various embodiments of the present invention, network 102 represents an intranet, a local area network (LAN), or a wide area network (WAN) such as the Internet, and may include wired, wireless, or fiber optic connections. In general, network 102 may be any combination of connections and protocols that may support communications between sensor data device 110, media device 112, demographics device 114, test data device 116, user device 118, and test integrity management device 120, in accordance with embodiments of the present invention. In the various embodiments, network 102 may be the Internet, representative of a worldwide collection of networks and gateways that may support communications between devices connected to the Internet.

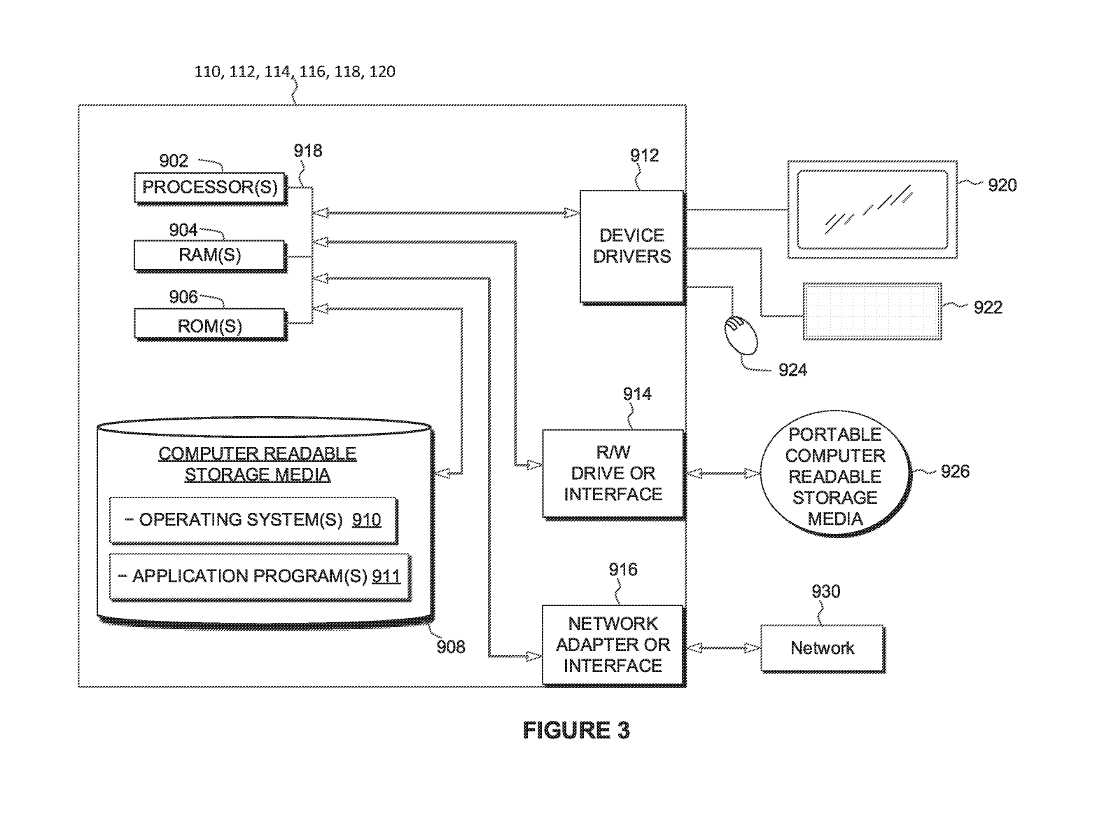

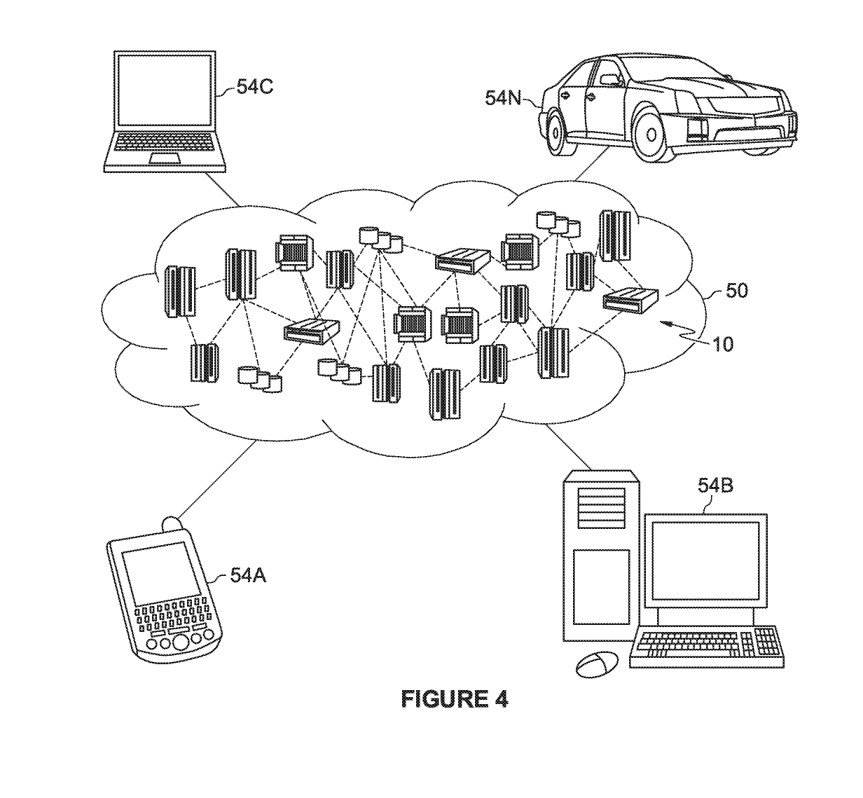

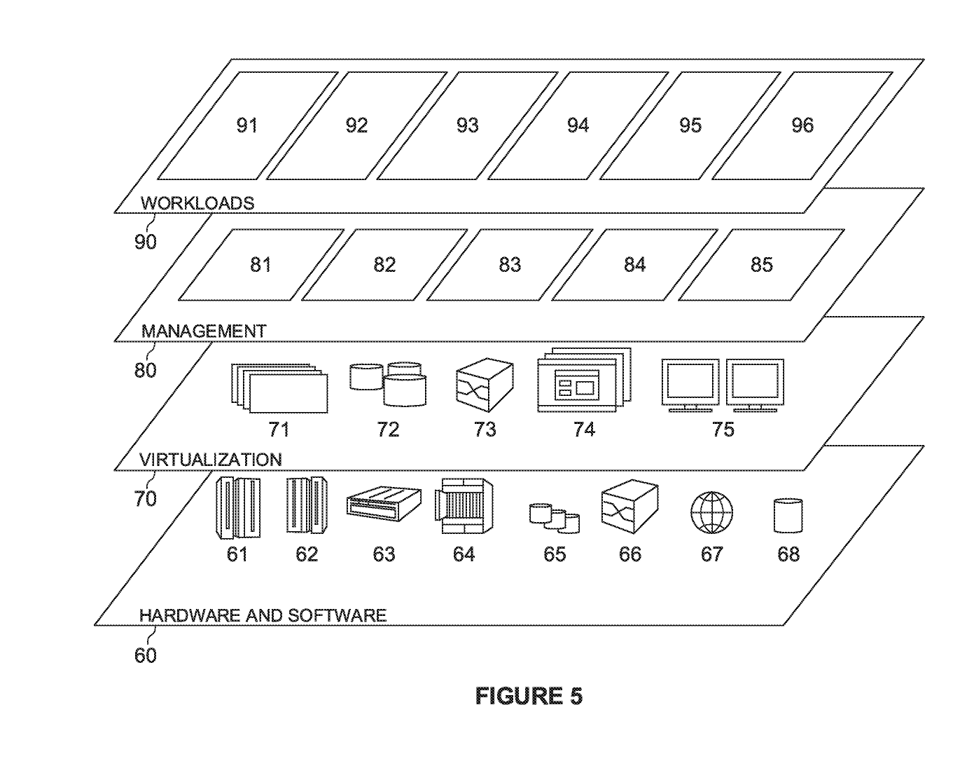

In various embodiments of the present invention, sensor data device 110, media device 112, demographics device 114, test data device 116, user device 118, and test integrity management device 120 each respectively represent individual computing platforms, such as a mobile or smart phone, a laptop computer, a desktop computer, a computer server, or the like. In the various embodiments, sensor data device 110, media device 112, demographics device 114, test data device 116, user device 118, or test integrity management device 120 may otherwise be any other type of computing platform, computing system, or information system capable of receiving and sending data to and from another device, by way of network 102. Sensor data device 110, media device 112, demographics device 114, test data device 116, user device 118, or test integrity management device 120 may include internal and external hardware components, as depicted and described with reference to FIG. 3. In other embodiments, sensor data device 110, media device 112, demographics device 114, test data device 116, user device 118, or test integrity management device 120 may be implemented in a cloud computing environment, as depicted and described with reference to FIGS. 4 and 5.

Sensor data device 110 represents a computing platform that may host sensor module 111. Sensor module 111 may be a sensor interface system, such as in the form of a program such as a software program, one or more subroutines contained in a program, an application programming interface, or the like, that communicates with test integrity management program 130, residing on test integrity management device 120. In various embodiments of the present invention, sensor module 111 may include and implement a combination of devices and technologies, such as network devices and corresponding device drivers, to provide a platform to enable communications between sensor data device 110 and test integrity management program 130.

Sensor module 111 may host sensor data, such as that received from sensors, transducers, and the like. In an embodiment of the present invention, the sensors may include, for example, radio-frequency identification (RFID) sensors, barcode scanners or readers, optical sensors, infrared (IR) sensors, cameras, video cameras such as used in video surveillance or closed-circuit television (CCTV) systems, and the like. In the embodiment, the sensors may be distributed throughout an environment, such as a testing environment or a test administration environment, to generate data with respect to test-takers of a test administration. Sensor module 111 may communicate with the sensors by way of a wireless sensor network, such as by way of a network gateway, or the like. Sensor module 111 may communicate with the sensors in accordance with a communications protocol, such as a sensor interface protocol or a simple sensor interface (SSI) protocol. The types of the sensors used may be chosen as a matter of design.

Media device 112 represents a computing platform, such as a social media platform, an electronic mail (email) platform, a messaging platform, or the like, that may host media application 113. Media application 113 may be a program such as a software program, one or more subroutines contained in a program, an application programming interface, or the like, that communicates with test integrity management program 130, residing on test integrity management device 120. In various embodiments of the present invention, media application 113 may include and implement a combination of devices and technologies, such as network devices and corresponding device drivers, to provide a platform to enable communications between media device 112 and test integrity management program 130.

Media application 113 may host media data, such as of the type in social media platforms, email platforms, messaging platforms, or the like. Media application 113 may serve as a source of data that may be data mined. Media application 113 may be a social media platform such as Facebook®, Twitter®, LinkedIn®, Tumblr®, Pinterest®, Instagram®, or the like. Media application 113 may otherwise be an email platform such as Gmail®, or the like, or a messaging platform such as Gchat®, or the like. A user may use media application 113 by creating a user account or profile. The user may be a test-taker, a proctor, a teacher, an instructor, an administrator, a supervisor, a manager, or the like. In an embodiment of the present invention, the user account may include, for example, historical activity data based on posted content or media, such as posted text, image, audio, or video content by the user, “likes” by the user, such as of similar forms of content posted by other users, and the like. In the embodiment, the historical activity data may additionally or alternatively be based on, for example, forums, common interest groups, and the like, of which the user may participate, or otherwise be a part. In the embodiment, the user account may further include, for example, data related to the user, such as with respect to demographics, interests, hobbies, contacts, biographics, or the like.

Demographics device 114 and test data device 116 each represent individual computing platforms that may respectively host demographics database 115 and test database 117. Demographics database 115 and test database 117 may each be a respective database-management system, such as in the form of a program such as a software program, one or more subroutines contained in a program, an application programming interface, or the like, that communicates with test integrity management program 130, residing on test integrity management device 120. In various embodiments of the present invention, demographics database 115 and test database 117 may each respectively include and implement a combination of devices and technologies, such as network devices and corresponding device drivers, to provide a platform to enable communications between demographics device 114 or test data device 116, respectively, and test integrity management program 130.

Demographics database 115 may host demographics data, such as of the type in a census database. Demographics database 115 may serve as a source of data that may be data mined. Demographics database 115 may be, for example, publically owned and operated, such as by a census bureau such as the United States Census Bureau, a public school or public school system, or the like. Demographics database 115 may otherwise be, for example, privately owned and operated, such as by a private school or private school system, by a corporation, or the like. The choice of the types of demographic information to mine with respect to individuals such as test-takers, and the choice of sources from which to mine the demographic information are a matter of design choice.

Test database 117 may host testing data and tested subject matter data, such as that respectively based on tests or examinations administered in the past, present, or future. Test database 117 may serve as a source of data that may be data mined. The tests of the past may include those historically administered to test-takers. The tests of the present may include those currently administered to test-takers. The tests of the future may include those anticipated to be administered to test-takers. In an embodiment of the present invention, the testing data may include, for example, data based on a test, such as with respect to questions and answers of the test, time allotted or otherwise required to complete the test, difficulty of the test, and the like. In the embodiment, the testing data may further include, for example, data based on performance by test-takers of a test, as well as test-taker data, based on characteristics of the test-takers of the test, such as with respect to historically administered tests to test-takers in the past. The respective characteristics of the test-takers may include or relate to learning characteristics of the test-takers, such as with respect to learning disabilities or required learning or testing accommodations, and may also include or relate to information regarding whether a test-taker, at testing time, was an honors student, “gifted,” or the like. In the embodiment, the tested subject matter data may include, for example, data based on tested subject matter by a test, such as with respect to tested concepts by the test. In the embodiment, the tested subject matter by a test may include or take the form of teaching or study materials such as lesson plans, assignments, projects, question and answer keys, study guides, or the like, as such may be associated with the test. In the embodiment, the tested subject matter data may further include, for example, data based on levels or degrees of difficulty of tested subject matter by a test, average or predicted amounts of time required to learn the tested subject matter, and the like. Other types of testing data and tested subject matter data used may be chosen as a matter of design.

In an embodiment of the present invention, the tests or examinations may include, for example, those administered for academic, professional, or vocational purposes, such as for assessment or evaluation in a field or topic of study, or for qualification, certification, registration, accreditation, or licensure in a field of practice. In an example, the tests may include those administered for academic purposes, such as in compulsory education, or primary education, secondary education, or K- or P-12 education. The tests may be administered by private schools, public schools, school systems, or the like, and may relate to subjects or topics of study, such as with respect to reading, writing, mathematics, biology, or the like. In the example, the tests may also or otherwise include standardized tests such as the general education diploma (GED) test, the scholastic aptitude test (SAT), the law school admissions test (LSAT), the dental admissions test (DAT), the graduate record examination (GRE), the medical college admissions test (MCAT), or the like. In the example, the tests may also or otherwise include those administered for professional or vocational purposes, such as bar exams, fundamentals of engineering exams, principles and practices in engineering exams, registration or licensing exams such as medical or cosmetology exams, driver's license exams, pilot licensing or proficiency tests, or the like. In the example, the tests may also or otherwise include those administered by employers, and may relate to workplace learning, workplace practices, or the like. In the example, tests also may include immigration or naturalization tests, intelligence quotient (IQ) tests, tests used in competitions, tests used in admitting members into clubs, or the like. The tests and related subject matter materials may otherwise include those relating to any type of test or examination, in accordance with embodiments of the present invention.

User device 118 represents a computing platform that may host testing application 119. Testing application 119 may be a test administration or administering application, such as in the form of program such as a software program, one or more subroutines contained in a program, an application programming interface, or the like, that communicates with test integrity management program 130, residing on test integrity management device 120. In various embodiments of the present invention, testing application 119 may include and implement a combination of devices and technologies, such as network devices and corresponding device drivers, to provide a platform to enable communications between user device 118 and test integrity management program 130.

Testing application 119 may host test data including user input data, such as with respect to a test of a test administration. Testing application 119 may implement a user interface such as a graphical user interface (GUI), or the like, to receive the user input data from a user with respect to the test of the test administration. The user may be a test-taker such as a student, a prospective student, an employee, a person seeking registration, qualification, certification, or a license to practice, or to continue to practice, in a particular field, or the like. The user may otherwise be a proctor, a teacher, an instructor, an administrator, a supervisor, a manager, or the like. In an embodiment of the present invention, testing application 119 may be implemented in a test-taking mode, to receive the user input data from the test-taker with respect to the test of the test administration. In the embodiment, testing application 119 may otherwise be implemented in a proctor mode, to receive the user input data from the proctor with respect to the test of the test administration. The proctor mode may be or otherwise include a teacher mode, an instructor mode, an administrator mode, a supervisor mode, a manager mode, or the like, accordingly. In an example, one or more test-takers and one or more proctors may each respectively use individual instances of testing application 119 with respect to a particular test administration, by way of respectively assigned user devices such as user device 118. In the example, each of the individual instances of testing application 119 may be respectively implemented in the test-taking mode or the proctor mode, for respective use by the test-takers and the proctors, accordingly.

Test integrity management device 120 represents a computing platform that may host test integrity management program 130. Test integrity management program 130 may include data collection module 132, cheating prediction module 134, test alteration module 136, and data storage 138. Test integrity management program 130 may be or utilize a program such as a software program, one or more subroutines contained in a program, one or more application programming interfaces, or the like, that communicates with sensor module 111, media application 113, demographics database 115, test database 117, and testing application 119, each respectively residing on sensor data device 110, media device 112, demographics device 114, test data device 116, and user device 118.

Data collection module 132 represents functionality of test integrity management program 130 that communicates with sensor module 111, media application 113, demographics database 115, test database 117, and testing application 119, to receive sensor data, media data, demographics data, testing data and tested subject matter data, and test data, respectively. Data collection module 132 may use one or more data crawlers, data miners, or other programs or methods, to periodically run queries such as database queries, and the like, to receive the data, accordingly. Data collection module 132 stores the received data in data storage 138, for later retrieval and use by test integrity management program 130. The received data may be stored in the form of, for example, separate computer-readable data files.

Cheating prediction module 134 represents functionality of test integrity management program 130 that determines a likelihood that a cheating event may occur with respect to a test administration in connection with one or more test-takers. In an embodiment of the present invention, cheating prediction module 134 may utilize natural language processing, sentiment analyses, behavioral analyses, computer vision and object recognition methods, classification engines, machine learning algorithms, or other programs or methods, to determine the likelihood that cheating may occur in connection with the test administration.

In an embodiment of the present invention, the cheating event may include an intended attempt to cheat or an actual act of cheating by a test-taker with respect to a test of a test administration. In the embodiment, the cheating event may otherwise include an intended attempt to facilitate cheating or an actual act of facilitating cheating by test-takers, a proctor, or the like, with respect to a test of a test administration, such as of the past or present.

Test alteration module 136 represents functionality of test integrity management program 130 that generates a test alteration for use in updating a test of a test-taker, determines a fairness value with respect to the generated test alteration, and adjusts the generated test alteration based on the determined fairness value, accordingly. The generated test alteration may be used in updating the test of the test-taker, such as by way of one or more corresponding test update operations. In an embodiment of the present invention, test alteration module 136 may utilize natural language processing, classification engines, semantic analysis methods, context analysis methods, data modeling methods, test alteration screening methods, machine learning algorithms, or other programs or methods, to generate the test alteration, determine the fairness value thereof, and adjust the generated test alteration, accordingly. In the embodiment, the generated test alteration may include, for example, that made with respect to one or more questions of the test, or that made with respect to one or more answers corresponding to a question of the test.

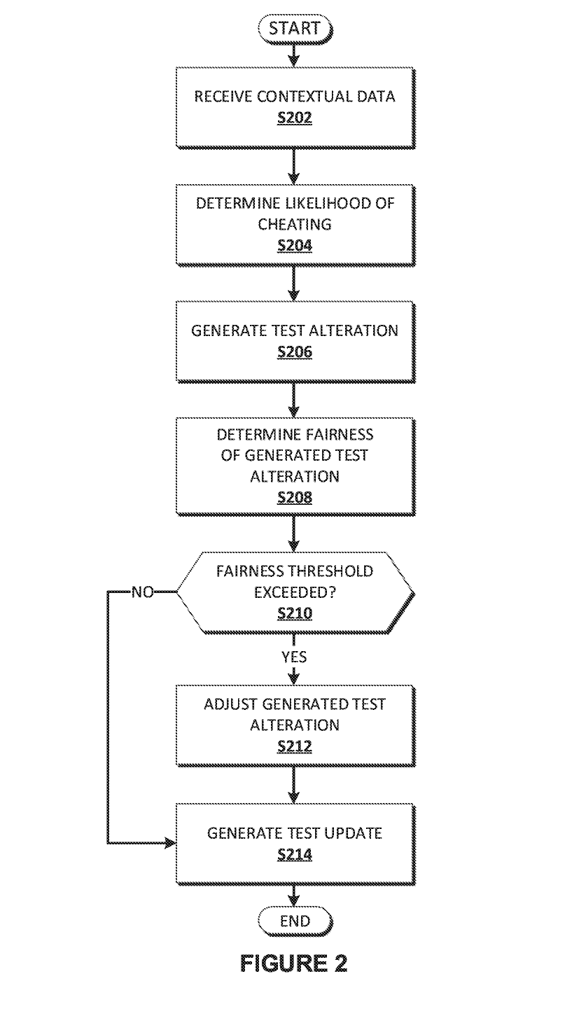

FIG. 2 is a flowchart depicting operational steps of an aspect of test integrity management system 100, in accordance with an embodiment of the present invention.

At step S202, data collection module 132 receives the sensor data, the media data, the demographics data, the testing data and the tested subject matter data, and the test data, from sensor module 111, media application 113, demographics database 115, test database 117, and testing application 119, respectively. In an embodiment of the present invention, the sensor data, the media data, the demographics data, the testing data, the tested subject matter data, and the test data, either individually or in combination, may form contextual data. The contextual data may be used, for example, to generate cheating risk information.

At step S204, cheating prediction module 134 determines a likelihood that a cheating event may occur with respect to a test administration in connection with one or more test-takers. In an embodiment of the present invention, cheating prediction module 134 may determine the likelihood that the cheating event may occur with respect to the test administration in connection with one or more of the test-takers based on contextual data meeting predefined criteria. The contextual data meeting the predefined criteria may be identified, for example, in accordance with training data input to cheating prediction module 134, and the machine learning algorithms and models used in training cheating prediction module 134. In the embodiment, the likelihood may otherwise be determined based on user input data included as part of the test data, such as from a proctor, indicating that an incident or occurrence of a cheating event is suspected with respect to the test administration. A predefined criterion may be defined, for example, in terms of data related to known indications of an intent to cheat or of an intent to facilitate cheating, past attempts to cheat, or the like. The terms by which the predefined criteria may be defined may be chosen a matter of design.

In an embodiment of the present invention, the sensor data forming the contextual data may include, for example, data relating to detected patterns of behavior by a test-taker or proctor, indicative of an attempt to cheat or to facilitate cheating, respectively. The data relating to the detected patterns of behavior, and the like, may be identified and characterized based on, for example, previously classified data, such as of the training data relating to similar such data. In an example, the data may take the form of sequences of images or videos generated by sensors such as a video surveillance system, a CCTV system, or the like, showing a test-taker using prohibited notes during a test administration, or showing a proctor allowing the use of prohibited notes by the test-taker during the test administration. In the example, the data may further take the form of an image generated by sensors such as RFID sensors, barcode scanners or readers, optical sensors, or the like, such as used in authenticating an identity of the test-taker by way of scanning of a driver's license, or the like, of the test-taker. In the example, the sequences of images or videos generated by the sensors such as used in the video surveillance system, and the image generated by the sensors such as used in authenticating the identity of the test-taker, may show a discrepancy with respect to an appearance of the test-taker, which may suggest that a proxy was sent to take the test for the test-taker.

In an embodiment of the present invention, the media data forming the contextual data may include, for example, data relating to detected patterns by a user based on historical activity data from one or more social media platforms, email platforms, messaging platforms, or the like. In the embodiment, the media data forming the contextual data may otherwise include any data or information indicative of an intent to cheat, or of an intent to facilitate cheating. In an example, the content may include an exchange such as between a proctor and a test-taker of an answer key to a test of a test administration, or the like. In another example, the content may include an exchange such as an email exchange between test-takers indicating an intent to cheat on a test to be administered in the future.

In an embodiment of the present invention, the test data and the demographics data forming the contextual data may include, for example, data meeting certain criteria which may be usable in determining a likelihood of an occurrence of a cheating event in connection with a test-taker. The contextual data may be generated, for example, with respect to a particular group of test-takers, a particular topic or course of study, or the like.

At step S206, test alteration module 136 generates a test alteration for use in updating a test of a test-taker. In an embodiment of the present invention, the test alteration may be generated in response to a determined likelihood that a cheating event may occur, to prevent the cheating event, or to otherwise decrease the likelihood of the occurrence of the cheating event. In the embodiment, the test alteration may be generated with respect to the test of the test-taker based on the testing data, the tested subject matter data, or both. In the embodiment, test alteration module 136 may utilize optimization and machine learning techniques, such as implemented by way of a deep learning model, to generate the test alteration.

In an embodiment of the present invention, a generated test alteration may include, for example, changes to content of a test such as presented questions of the test, changes to an order of the content of the test such as with respect to the presented questions of the test, changes to elements or aspects of the content of the test such as with respect to a question of the test, and the like. In the embodiment, the changes to the presented questions of the test may include, for example, replacement of one or more questions of the test with similar questions drawn from one or more tests of the past or present. The similar tests may include those testing similar concepts.

For example, in a mathematics test, a question that may have been to be presented in a test of a test administration may be replaced with a question drawn from a test administered to test-takers in the past. In the embodiment, the variations in the order of presented questions may be, for example, randomized, with respect to an order of questions presented to other test-takers of a test administration. In the embodiment, the variations in the elements of a question may include, for example, alterations to numbers, words, figures, drawings, flowcharts, and the like, of the question. For example, in a mathematics test assessing knowledge of rudimentary algebra, a question such as “2x=4,” having an answer “x=2,” may be changed to “2x=6,” having an answer “x=3,” and so on. Other similar types of changes may equally be applied to other numbers, words, figures, drawings, or flowcharts, relating to any subject, topic, or concept that may be tested.

In an embodiment of the present invention, the test alteration may be generated with respect to static features of a test administration, such as with respect to tested concepts by a test of the test administration. In the embodiment, the static features may include, for example, concept density of tested subject matter, a type or complexity of the tested subject matter, a comprehension burden of the tested subject matter, a form of the tested subject matter. The concept density may relate to, for example, a number of prerequisite concepts required to correctly answer a question. In the embodiment, the test alteration may additionally or alternatively be generated with respect to dynamic features of the test administration, such as with respect to test-takers of the test of the test administration. In the embodiment, the dynamic features may include, for example, levels of proficiency, levels of engagement, and the like, of the test-takers. In the embodiment, the dynamic features may further relate to environmental conditions of the test administration, and the like. The static and dynamic features of the test administration may be chosen as a matter of design.

In various embodiments of the present invention, a blockchain technology may be used for storing, managing, and maintaining a test bank, such as formed by the testing data and the tested subject matter data, as previously described. In the various embodiments, data representing determined likelihoods that cheating events may occur, with respect to corresponding tests of test administrations in connection with one or more test-takers, may be stored and associated with blocks of the blockchain, accordingly. In the various embodiments, other data that may be stored and associated with the blocks of the blockchain may include, for example, data representing test difficulty or complexity, tested subject matter ontology or taxonomy, recommended time to complete a test, determined fairness values of respective test alterations, testing standards such as defined with respect to Bloom's taxonomy, and the like. Generally, the types of data stored and associated with the blocks of the blockchain may be chosen as a matter of design.

At step S208, test alteration module 136 determines a fairness value with respect to a generated test alteration. In an embodiment of the present invention, the fairness value may be determined based on a determined risk of alteration associated with the test alteration, and may include a multidimensional fairness value. In the embodiment, the multidimensional fairness value may be computed with respect to a group of test-takers of a test administration, in terms of a field of knowledge being tested, a grade level, similar groups of other test-takers of other respective test administrations, the static features, the dynamic features, or the like.

In an embodiment of the present invention, the multidimensional fairness value may be computed based on one or more of a risk of misrepresentation of a tested concept, a risk of over- or under-alteration, a predicted proficiency level of a test-taker, a risk that an alteration may cause an undue amount or level of difficulty, and the like. The multidimensional fairness value may be determined based on the testing data and the tested subject matter data, accordingly, such as with respect to tests administered to test-takers in the past. In the embodiment, a dimension of the multidimensional fairness value may be computed with respect to a risk of misrepresenting the tested concept, which may be determined based on, for example, Bloom's taxonomy. Bloom's taxonomy is used to classify educational learning objectives into levels of complexity and specificity. For example, where a test alteration is generated with respect to a tested concept such that it does not adhere to an educational learning objective, such as by exceeding or otherwise falling below a level of complexity or specificity as in corresponding teaching materials for the tested concept, the generated test alteration may be determined to have a high risk of misrepresenting the tested concept. In the embodiment, the other dimensions of the multidimensional fairness value may be computed with respect to risks of over- or under-alteration, or the predicted proficiency level of the test-taker, respectively. The risk of over- or under-alteration may include over- or under-complication, over- or under-simplification, and the like. The other dimensions may be determined based on, for example, comparisons with similar tests of other test administrations involving other test-takers, with respect to the other test-takers' proficiency levels, respectively. In the embodiment, the multidimensional fairness value may be computed using techniques as described in “Automated Generation of Assessment Tests from Domain Ontologies,” which is incorporated herein by reference. Generally, the manner of computing the multidimensional fairness value may be determined as a matter of design.

At step S210, test alteration module 136 determines whether the determined fairness value of the generated test alteration meets or exceeds a predetermined threshold value. In an embodiment of the present invention, where the determined fairness value of the generated test alteration meets or exceeds the predetermined threshold value, the generated test alteration may be adjusted, accordingly. In the embodiment, the adjusted test alteration may be used in generating a corresponding test update, accordingly. The manner of determining whether the determined fairness value of the generated test alteration meets or exceeds the predetermined threshold value may be chosen as a matter of design.

At step S212, test alteration module 136 adjusts the generated test alteration based on the determined fairness value, accordingly. In an embodiment of the present invention, the adjusting of the generated test alteration may include, for example, generating and adding a hint to the generated test alteration, extending a time to complete a question associated with the generated test alteration, or the like. In the embodiment, the adjusting of the generated test alteration may be affected or applied collaboratively with a proctor, for example, by way of received user input data from the proctor. For example, if the proctor suspects that a cheating event may occur during a test administration, the proctor may indicate such in user input data, by way of testing application 119. In the embodiment, the adjusting of the generated test alteration may be affected, for example, in accordance with techniques as described with reference to step S206, above. In various embodiments of the present invention, the adjusting of the generated test alteration may be affected for use in administering similar variants of a test across grade levels.

At step S214, the generated test alteration may be used in updating the test of the test-taker. In an embodiment of the present invention, updating the test of the test-taker may be affected by performing a corresponding test update operation. The test of the test-taker may be updated before or during a corresponding test administration, accordingly. In the embodiment, the update may be affected by way of, for example, testing application 119 implemented in the test-taking mode. In the embodiment, one or more test update operations may be respectively performed with respect to one or more corresponding questions of the test. In the embodiment, one or more test update operations may otherwise be performed to update the entire test, accordingly.

FIG. 3 is a block diagram depicting sensor data device 110, media device 112, demographics device 114, test data device 116, user device 118, and/or test integrity management device 120, in accordance with an embodiment of the present invention.

As depicted in FIG. 3, sensor data device 110, media device 112, demographics device 114, test data device 116, user device 118, and/or test integrity management device 120 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as test integrity management program 130 residing on test integrity management device 120, as depicted in FIG. 1, are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Sensor data device 110, media device 112, demographics device 114, test data device 116, user device 118, and/or test integrity management device 120 may also include a R/W drive or interface 914 to read from and write to one or more portable computer readable storage media 926. Application programs 911 on sensor data device 110, media device 112, demographics device 114, test data device 116, user device 118, and/or test integrity management device 120 may be stored on one or more of the portable computer readable storage media 926, read via the respective R/W drive or interface 914 and loaded into the respective computer readable storage media 908. Sensor data device 110, media device 112, demographics device 114, test data device 116, user device 118, and/or test integrity management device 120 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OFDMA) technology). Application programs 911 on the server 220 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers. Sensor data device 110, media device 112, demographics device 114, test data device 116, user device 118, and/or test integrity management device 120 may also include a display screen 920, input devices such as a keyboard or keypad 922, and a computer mouse or touchpad 924. In embodiments of the present invention, user computing device 110 may also include the sensor module 212. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may include hardware and software (stored on computer readable storage media 908 and/or ROM 906).

Test integrity management device 120 can be a standalone network server, or represent functionality integrated into one or more network systems. In general, sensor data device 110, media device 112, demographics device 114, test data device 116, user device 118, and/or test integrity management device 120 can be a laptop computer, desktop computer, specialized computer server, or any other computer system known in the art. In certain embodiments, test integrity management device 120 represents computer systems utilizing clustered computers and components to act as a single pool of seamless resources when accessed through a network, such as a LAN, WAN, or a combination of the two. This implementation may be preferred for data centers and for cloud computing applications. In general, sensor data device 110, media device 112, demographics device 114, test data device 116, user device 118, and/or test integrity management device 120 can be any programmable electronic device, or can be any combination of such devices.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and solar power forecasting 96. Test integrity management 96 may include functionality enabling the cloud computing environment to be used to generate test alterations, determine fairness values with respect to the generated test alterations, and adjust the generated test alterations based on the determined fairness values, in accordance with embodiments of the present invention.

While the invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the present invention has been disclosed by way of example for purposes of illustration, and not limitation.

What is claimed is:

1. A computer-implemented method, comprising:
receiving contextual data associated with a test administration;
determining a likelihood of an incident of a cheating event by a test-taker based on a predefined criterion that is met by the received contextual data;
generating a test alteration based on testing data and tested subject matter data related to a test administered to the test-taker during the test administration, wherein the test alteration is generated in accordance with the determined likelihood of the incident of the cheating event; and
updating the test administered to the test-taker based on the generated test alteration.

2. The computer-implemented method of claim 1, further comprising:
determining a fairness value with respect to the generated test alteration; and
adjusting the generated test alteration based on predetermined threshold values that are met by the determined fairness value.

3. The computer-implemented method of claim 1, wherein:
the contextual data comprises data generated by a camera with respect to the test-taker; and
determining the likelihood of the incident of the cheating event comprises identifying patterns of behavior indicative of an attempt to cheat by the test-taker based on the data generated by the camera that meets the predefined criterion.

4. The computer-implemented method of claim 3, wherein:
the contextual data further comprises data generated by an infrared sensor with respect to the test-taker; and
determining the likelihood of the incident of the cheating event further comprises identifying the patterns of behavior indicative of the attempt to cheat by the test-taker based on the data generated by the infrared sensor that meets the predefined criterion.

5. The computer-implemented method of claim 1, wherein:
the contextual data comprises historical social media activity data associated with the test-taker; and
determining the likelihood of the incident of the cheating event comprises identifying patterns of behavior indicative of an attempt to cheat by the test-taker based on the historical social media activity data that meets the predefined criterion.

6. The computer-implemented method of claim 1, wherein:
the contextual data comprises data generated by a radio-frequency identification sensor with respect to the test-taker; and
determining the likelihood of the incident of the cheating event comprises identifying a discrepancy in appearance of the test-taker based on the data generated by the radio-frequency identification sensor that meets the predefined criterion.

7. The computer-implemented method of claim 6, wherein:
the contextual data further comprises data generated by a camera with respect to the test-taker; and
determining the likelihood of the incident of the cheating event further comprises identifying the discrepancy in the appearance of the test-taker based on the data generated by the camera that meets the predefined criterion.

8. A computer system comprising:
one or more computer processors, one or more computer-readable storage media, and program instructions stored on one or more of the computer-readable storage media for execution by at least one of the one or more computer processors, the program instructions, when executed by the at least one of the one or more computer processors, causing the computer system to perform a method comprising:
receiving contextual data associated with a test administration;
determining a likelihood of an incident of a cheating event by a test-taker based on a predefined criterion that is met by the received contextual data;
generating a test alteration based on testing data and tested subject matter data related to a test administered to the test-taker during the test administration, wherein the test alteration is generated in accordance with the determined likelihood of the incident of the cheating event; and
updating the test administered to the test-taker based on the generated test alteration.

9. The computer system of claim 8, the method further comprising:
determining a fairness value with respect to the generated test alteration; and
adjusting the generated test alteration based on predetermined threshold values that are met by the determined fairness value.

10. The computer system of claim 8, wherein:
the contextual data comprises data generated by a camera with respect to the test-taker; and
determining the likelihood of the incident of the cheating event comprises identifying patterns of behavior indicative of an attempt to cheat by the test-taker based on the data generated by the camera that meets the predefined criterion.

11. The computer system of claim 10, wherein:
the contextual data further comprises data generated by an infrared sensor with respect to the test-taker; and
determining the likelihood of the incident of the cheating event further comprises identifying the patterns of behavior indicative of the attempt to cheat by the test-taker based on the data generated by the infrared sensor that meets the predefined criterion.

12. The computer system of claim 8, wherein:
the contextual data comprises historical social media activity data associated with the test-taker; and
determining the likelihood of the incident of the cheating event comprises identifying patterns of behavior indicative of an attempt to cheat by the test-taker based on the historical social media activity data that meets the predefined criterion.

13. The computer system of claim 8, wherein:
the contextual data comprises data generated by a radio-frequency identification sensor with respect to the test-taker; and
determining the likelihood of the incident of the cheating event comprises identifying a discrepancy in appearance of the test-taker based on the data generated by the radio-frequency identification sensor that meets the predefined criterion.

14. The computer system of claim 13, wherein:
the contextual data further comprises data generated by a camera with respect to the test-taker; and
determining the likelihood of the incident of the cheating event further comprises identifying the discrepancy in the appearance of the test-taker based on the data generated by the camera that meets the predefined criterion.

15. A computer program product comprising:
one or more computer-readable storage devices and program instructions stored on at least one of the one or more computer-readable storage devices for execution by at least one or more computer processors of a computer system, the program instructions, when executed by the at least one of the one or more computer processors, causing the computer system to perform a method comprising:
receiving contextual data associated with a test administration;
determining a likelihood of an incident of a cheating event by a test-taker based on a predefined criterion that is met by the received contextual data;
generating a test alteration based on testing data and tested subject matter data related to a test administered to the test-taker during the test administration, wherein the test alteration is generated in accordance with the determined likelihood of the incident of the cheating event; and
updating the test administered to the test-taker based on the generated test alteration.

16. The computer program product of claim 15, the method further comprising:
determining a fairness value with respect to the generated test alteration; and
adjusting the generated test alteration based on predetermined threshold values that are met by the determined fairness value.

17. The computer program product of claim 15, wherein:
the contextual data comprises data generated by a camera with respect to the test-taker; and
determining the likelihood of the incident of the cheating event comprises identifying patterns of behavior indicative of an attempt to cheat by the test-taker based on the data generated by the camera that meets the predefined criterion.

18. The computer program product of claim 17, wherein:
the contextual data further comprises data generated by an infrared sensor with respect to the test-taker; and
determining the likelihood of the incident of the cheating event further comprises identifying the patterns of behavior indicative of the attempt to cheat by the test-taker based on the data generated by the infrared sensor that meets the predefined criterion.

19. The computer program product of claim 15, wherein:
the contextual data comprises historical social media activity data associated with the test-taker; and
determining the likelihood of the incident of the cheating event comprises identifying patterns of behavior indicative of an attempt to cheat by the test-taker based on the historical social media activity data that meets the predefined criterion.

20. The computer program product of claim 15, wherein:
the contextual data comprises data generated by a radio-frequency identification sensor with respect to the test-taker; and
determining the likelihood of the incident of the cheating event comprises identifying a discrepancy in appearance of the test-taker based on the data generated by the radio-frequency identification sensor that meets the predefined criterion.
